(19) United States
(12) Patent Application Publication
(10) Pub. No.: US 2021/0210855 A1
(43) Pub. Date: Jul. 8, 2021

(54) DUAL-POLARIZED CORNER-TRUNCATED STACKED PATCH ANTENNA WITH ENHANCED SUPPRESSION OF CROSS-POLARIZATION AND SCAN PERFORMANCE FOR WIDE SCAN ANGLES

(71) Applicant: HUGHES NETWORK SYSTEMS, LLC, Germantown, MD (US)

(72) Inventors: Taiwei YUE, Germantown, MD (US); Peter HOU, Germantown, MD (US); Bingqian LU, Germantown, MD (US); Kunj DESAI, Germantown, MD (US)

(73) Assignee: HUGHES NETWORK SYSTEMS, LLC, Germantown, MD (US)

(21) Appl. No.: 16/732,862

(22) Filed: Jan. 2, 2020

(51) Int. Cl. H01Q 9/04; H01Q 1/48

(52) U.S. Cl. CPC H01Q 9/0428; H01Q 9/0421; H01Q 9/0414; H01Q 1/48

(57) ABSTRACT

Embodiments for an antenna structure that can also be used in an antenna array are described. Each antenna element includes a ground plane that includes a conductive material. Each antenna element also includes an antenna patch disposed on the ground plane. The antenna patch includes a base portion formed from an insulating material, and a conductive element disposed on the base portion and having a rectangular shape with a first length and a first width. The ground plane is larger than the conductive element. Additionally, each corner of the conductive element includes a rectangular region void of conductive material. The rectangular regions in each corner include a second length that is less than one half of the first length of the rectangular shape, and a second width that is less than one half of the first width of the rectangular shape.

### BACKGROUND INFORMATION

Modern communication technologies have enabled delivery of multimedia services (e.g., voice, data, video, etc.) to end-users over various delivery platforms, including terrestrial wire-line, fiber and wireless communications and networking technologies, and satellite communications and networking technologies. The relatively recent proliferation of mobile communications has spurred growth in the demand for such enhanced multimedia services over fixed and mobile communications networks (both terrestrial and satellite based). Developments in both fixed and mobile wireless communications have enabled consumers to remain connected without the need to have a wired connection. For example, satellite communication systems allow consumers to access voice and data services from virtually any global location. Such accessibility can be beneficial for consumers who are located in, or must travel to, areas that cannot be serviced by other (e.g. terrestrial) communication systems.

These services can be accessed, in part, using a satellite terminal that includes an outdoor antenna. The terminal antenna is typically mounted on a stationary fixed structure, such as a home. In order to maximize operation in the satellite communication, the terminal antenna requires an ability to form a steerable beam that can be automatically pointed to a satellite. The terminal antenna can require a repointing of the antenna beam to compensate for minor antenna movements due to ground settlement, ground freezing/thawing cycles, etc. or to point to a different satellite. Furthermore, when a terminal antenna is used on moving or portable platforms, such as cars, trains, boats, or airplanes, the antenna can further require a cost-effective way of fast beam steering or tracking that constantly points the antenna beam toward a desired satellite.

Specialized antennas and antenna arrays such as phased array antennas are becoming popular in both home and moving satellite communication platforms due to their compactness. Phased array antennas can also be used in other application including, but not limited to, cellular networks and internet of things (TOT) networks. Typically, phased array antennas are partially mechanically steered. Phased array antennas electronically steer the beam in the elevation plane and employ a motor included in antenna mount to rotate the antenna array in the azimuth plane. This configuration is capable of maintaining the required cross-polarization discrimination (XPD) performance for the satellite system through the range of elevation and azimuth adjustment with no requirement in terms of XPD in non-principal planes. However, such a configuration is bulky and not suitable for certain applications, such a moving or portable platform. Based on the foregoing, there is a need for an approach to a phased array antenna that is electronically steerable in both the elevation and azimuth planes.

### BRIEF SUMMARY

An apparatus with enhanced suppression for cross-polarization and improved performance for wide scan angles is described. According to an embodiment, the apparatus includes: a ground plane comprising a conductive material; and an antenna patch disposed on the ground plane. The antenna patch includes: a base portion formed from an insulating material, and a conductive element disposed on the base portion and having a rectangular shape with a first length and a first width. The ground plane is larger than the conductive element, each corner of the conductive element includes a rectangular region void of conductive material, and the rectangular regions in each corner include a second length that is less than one half of the first length of the rectangular shape, and a second width that is less than one half of the first width of the rectangular shape.

According to another embodiment, the apparatus includes: an antenna array including a plurality of antenna elements. Each antenna element includes: a ground plane comprising a conductive material; and an antenna patch disposed on the ground plane, and including: a base portion formed from an insulating material, and a conductive element disposed on the base portion and having a rectangular shape with a first length and a first width. The ground plane is larger than the conductive element, each corner of the conductive element includes a rectangular region void of conductive material, and the rectangular regions in each corner include a second length that is less than one half of the first length of the rectangular shape, and a second width that is less than one half of the first width of the rectangular shape.

The foregoing summary is only intended to provide a brief introduction to selected features that are described in greater detail below in the detailed description. As such, this summary is not intended to identify, represent, or highlight features believed to be key or essential to the claimed subject matter. Furthermore, this summary is not intended to be used as an aid in determining the scope of the claimed subject matter.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing voice and data services, according to at least one embodiment;

FIG. 2 is a diagram of a terminal such as used in the system of FIG. 1, according to one embodiment;

FIG. 3 is a cross-sectional view of a portion of an outdoor antenna, unit according to at least one embodiment;

FIG. 4A is an exploded view of an antenna structure, according to at least one embodiment;

FIG. 4B is a cross-sectional view of the antenna structure shown in FIG. 4A;

FIG. 5 is a top view of another antenna structure, according to at least one embodiment;

FIG. 6A is an exploded view of a further antenna structure, according to at least one embodiment;

FIG. 6B is a cross-sectional view of the antenna structure shown in FIG. 6A;

FIG. 7A is an exploded view of another antenna structure, according to at least one embodiment;

FIG. 7B is a cross-sectional view of the antenna structure shown in FIG. 6A;

FIG. 8 is a top view of an antenna array, according to at least one embodiment;

FIG. 9 is a diagram of a computer system that can be used to implement various exemplary features and embodiments; and

FIG. 10 is a diagram of a chip set that can be used to implement various exemplary features and embodiments.

### DETAILED DESCRIPTION

An apparatus for implementing a phased array antenna that is electronically steerable in both the elevation and azimuth planes is described. In the following description, for purposes of explanation, numerous specific details are set forth in order to provide a thorough understanding of the disclosed embodiments. It will become apparent, however, to one skilled in the art that various embodiments may be practiced without these specific details or with an equivalent arrangement. In other instances, well-known structures and devices are shown in block diagram form in order to avoid unnecessarily obscuring the various embodiments.

The present embodiments implement a phased array antenna using a set of patch antenna elements can reduce or eliminate the need for a mechanical structure such as a motor automatically adjust or steer the phased array antenna in the azimuth plane as is typically required. Each of the patch antenna elements include rectangular regions in each of the corners that are void of conductive material, referred to as truncated corners. The truncated corners in the patch antenna elements improve the XPD performance along the diagonal axes of the elements as well as the antenna array. The improvement in XPD performance allows main lobe or beam antenna transmission pattern or to be electronically steered over a wide range of values in both the azimuth plane and elevation plane with respect to the physical antenna position. When used with a fixed terminal communicating with fixed satellite, the present embodiments provide a mechanism to automatically point the beam of the antenna to any of the satellites in the network and periodically repoint the antenna beam to compensate for minor antenna movements due to ground settlement, ground freezing/thawing cycles, etc. When used with a portable terminal (e.g., on a car, train, airplane) or with non-geostationary satellites, the present embodiments provide a mechanism that can be used for electronic fast beam tracking that maintain stable performance while the portable terminal is moving.

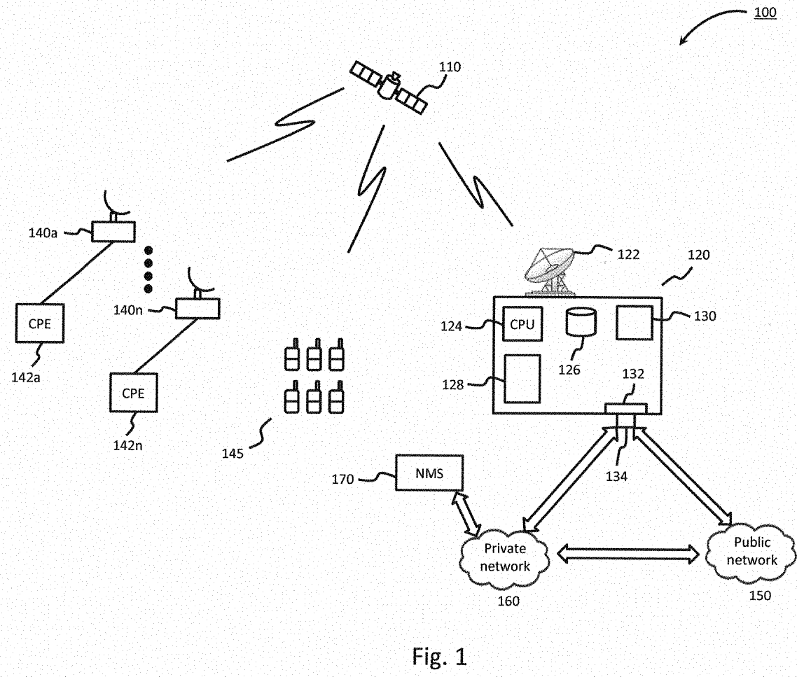

FIG. 1 illustrates a satellite communication system 100 capable of providing voice and data services. The satellite communication system 100 includes a satellite 110 that supports communications among a number of gateways 120 (only one shown) and multiple stationary satellite terminals 140a-140n. Each satellite terminal (or terminal) 140 can be configured for relaying traffic between its customer premise equipment (CPEs) 142a-142n (i.e., user equipment), a public network 150, such as the internet, and/or its private network 160. Depending on the specific embodiment, the CPEs 142 can be a desktop computer, laptop, tablet, cell phone, etc. CPEs 142 can also be in the form of connected appliances that incorporate embedded circuitry for network communication can also be supported by the satellite terminal (or terminal) 140. Connected appliances can include, without limitation, televisions, home assistants, thermostats, refrigerators, ovens, etc. The network of such devices is commonly referred to as the IoT.

According to an exemplary embodiment, the terminals 140 can be in the form of very small aperture terminals (VSATs) that are mounted on a structure, habitat, etc. Depending on the specific application, however, the terminal 140 can incorporate an antenna dish of different sizes (e.g., small, medium, large, etc.). The terminals 140 typically remain in the same location once mounted, unless otherwise removed from the mounting. According to various embodiments, the terminals 140 can be mounted on mobile platforms that facilitate transportation thereof from one location to another. Such mobile platforms can include, for example, cars, buses, boats, planes, etc. The terminals 140 can further be in the form of transportable terminals capable of being transported from one location to another. Such transportable terminals are operational only after arriving at a particular destination, and not while being transported.

As illustrated in FIG. 1, the satellite communication system 100 can also include a plurality of mobile terminals 145 that are capable of being transported to different locations by a user. In contrast to transportable terminals, the mobile terminals 145 remain operational while users travel from one location to another. The terms user terminal, satellite terminal, terminal may be used interchangeably herein to identify any of the foregoing types. The gateway 120 can be configured to route traffic from stationary, transportable, and mobile terminals (collectively terminals 140) across the public network 150 and private network 160 as appropriate. The gateway 120 can be further configured to route traffic from the public network 150 and private network 160 across the satellite link to the appropriate terminal 140. The terminal 140 then routes the traffic to the appropriate CPE 142.

According to at least one embodiment, the gateway 120 can include various components, implemented in hardware, software, or a combination thereof, to facilitate communication between the terminals 140 and external networks 150, 160 via the satellite 110. According to an embodiment, the gateway 120 can include a radio frequency transceiver (RFT) 122, a processing unit 124 (or computer, central processing unit (CPU), etc.), and a data storage unit 126 (or storage unit). While generically illustrated, the processing unit 124 can encompass various configurations including, without limitations, a personal computer, laptop, server, etc. As used herein, a transceiver corresponds to any type of antenna unit used to transmit and receive signals, a transmitter, a receiver, etc. The RFT 122 is useable to transmit and receive signals within a communication system such as the satellite communication system 100 illustrated in FIG. 1. The data storage unit 126 can be used, for example, to store and provide access to information pertaining to various operations in the satellite communication system 100. Depending on the specific implementation, the data storage unit 126 (or storage unit) can be configured as a single drive, multiple drives, an array of drives configured to operate as a single drive, etc.

According to other embodiments, the gateway 120 can include multiple processing units 124 and multiple data storage units 126 in order to accommodate the needs of a particular system implementation. Although not illustrated in FIG. 1, the gateway 120 can also include one or more workstations 125 (e.g., computers, laptops, etc.) in place of, or in addition to, the one or more processing units 124. Various embodiments further provide for redundant paths for components of the gateway 120. The redundant paths can be associated with backup components capable of being seamlessly or quickly switched in the event of a failure or critical fault of the primary component.

According to the illustrated embodiment, the gateway 120 includes baseband components 128 which operate to process signals being transmitted to, and received from, the satellite 110. For example, the baseband components 128 can incorporate one or more modulator/demodulator units, system timing equipment, switching devices, etc. The modulator/demodulator units can be used to generate carriers that are transmitted into each spot beam and to process signals received from the terminals 140. The system timing equipment can be used to distribute timing information for synchronizing transmissions from the terminals 140.

According to an embodiment, a fault management unit 130 can be included in the gateway 120 to monitor activities and output one or more alerts in the event of a malfunction in any of the gateway components. The fault management unit 130 can include, for example, one or more sensors and interfaces that connect to different components of the gateway 120. The fault management unit 130 can also be configured to output alerts based on instructions received from a remotely located network management system 170 (NMS). The NMS 170 maintains, in part, information (configuration, processing, management, etc.) for the gateway 120, and all terminals 140 and beams supported by the gateway 120. The gateway 120 can further include a network interface 132, such as one or more edge routers, for establishing connections with a terrestrial connection point 134 from a service provider. Depending on the specific implementation, however, multiple terrestrial connection points 134 may be utilized.

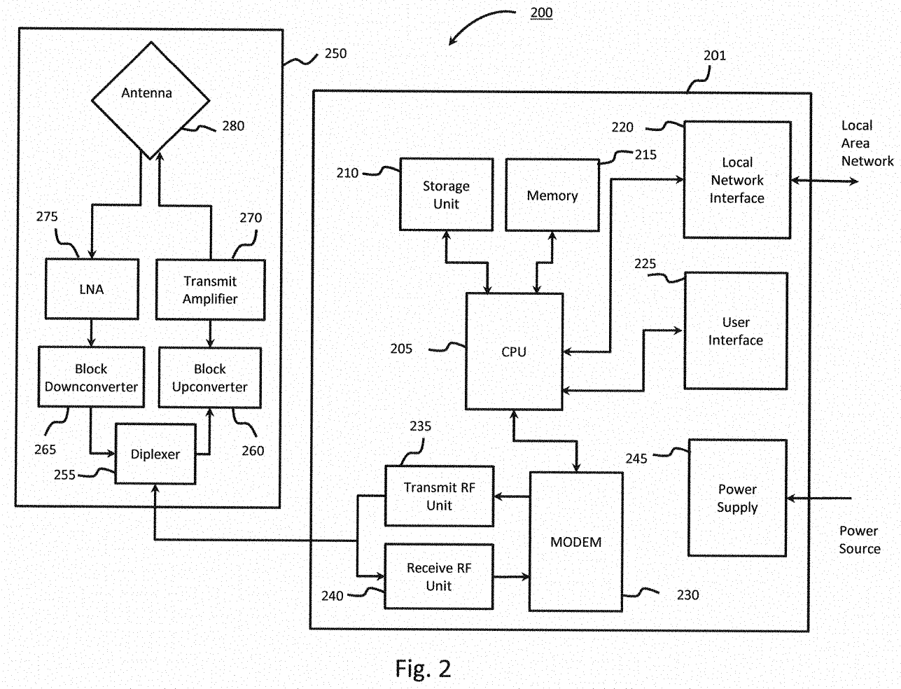

FIG. 2 is a diagram of an exemplary terminal 200 used in the system of FIG. 1, according to one embodiment. Terminal 200 can operate as a fixed satellite terminal, such as one of the terminals 140 described in FIG. 1. Terminal 200 can alternatively operate as a mobile satellite terminal, such as one of the mobile terminals 145 described in FIG. 1. Terminal 200 includes an indoor unit 201 coupled to an outdoor antenna unit 250. The indoor unit 201 can be coupled to the outdoor antenna unit 250 located outside the customer premises through a wired communication medium such as coaxial cable.

The indoor unit 201, can include a CPU 205 is coupled to a storage unit 210, a memory 215, a local network interface 220, a user interface 225, and a modem 230. Modem 230 is further coupled to a transmit radio frequency (RF) unit 235 and a receive RF unit 240 which receive signals from and provide signals to outdoor antenna unit 250. Although not shown, power supply 245 can be coupled to each of the blocks shown in indoor unit 201 that require local electrical power and can also provide electrical power to outdoor antenna unit 250. In outdoor antenna unit 250, the signal interface from transmit RF unit 235 and receive RF unit 240 in indoor unit 201 is coupled to diplexer 255. Diplexer 255 is coupled to block upconverter 260 and block downconverter 265. Block upconverter 260 is coupled to transmit amplifier 270. Block downconverter 265 is coupled to low noise amplifier (LNA) 275. Both transmit amplifier 270 and LNA 275 are coupled to antenna 280. It should be noted that indoor unit 201 can include various additional components which perform conventional operations. Such components are known to those skilled in the art and are omitted in order to provide better clarity and conciseness in describing the novel features of indoor unit 201.

CPU 205 can include one or more specifically built processing elements and/or general purpose processors configured or programmed to perform specific tasks associated with the operation, control, and management of activity in indoor unit 201 as well as, in some instances, outdoor antenna unit 250. Storage unit 210 can be any one of several large and/or removable storage elements including, but not limited to, magnetic disk, and optical disk. Memory 215 can be any type of electronic circuit or small scale based storage elements including, but not limited to read-only memory (ROM), erasable electrically programmable ROM (EEPROM), random-access memory (RAM), non-volatile RAM (NVRAM), flash memory, or other similar memory technology. Storage unit 210 and/or memory 215 can be used to store instructions or software code used by CPU 205 and data associated with operations of terminal 200 (e.g., indoor unit 201 and/or outdoor antenna unit 250). Storage unit 210 can also be used for longer term storage of data and/or multimedia content transmitted and/or received through modem 230 or local network interface 220. Memory 215 can be used for shorter term or temporary storage of data and/or multimedia content needed for, or associated with, signal and data processing in terminal 200.

Local network interface 220 includes circuit elements for configured for interfacing to one or more home networks and/or other similar local area networks (LANs). Local network interface 220 also includes interface components for connecting to the home networks and/or LANS either through a wired medium or wirelessly. Local network interface 220 receives data and/or multimedia content, along with processing instructions, from CPU 205 for delivery to devices such as CPEs 142 on the home and/or local area networks. For example, a home computer in a user's local home network employing Ethernet protocols can be interfaced to local network interface 220 through a registered jack (RJ) type 45 receptacle using category 5 (CAT 5) cable. Further, a user's cell phone can be connected wirelessly to local network interface 220 through an antenna (not shown) in order to utilize indoor unit 201 as a Wi-Fi signal router or hotspot.

User interface 225 can include a user input or entry mechanism, such as a set of buttons, a keyboard, or a microphone. User interface 225 can also include circuitry for converting user input signals into a data communication format to provide to CPU 205. User interface 225 can further include some form of user notification mechanism to show device functionality or status, such as indicator lights, a speaker, or a display. User interface 225 can also include circuitry for converting data received from CPU 205 to signals that may be used with the user notification mechanism.

Modem 230 performs all the functions necessary for modulating and demodulating a signal to/from transmit RF unit 235 and receive RF unit 240. These elements and/or functions can include, but are not limited to, digital signal conditioning, symbol mapping, demapping, data error correction encoding/decoding, and transport stream processing for interfacing data to and from the CPU 205. According to various embodiments, modem 230 can perform the modulating/demodulating functions independently or under control of the CPU 205. Transmit RF unit 235 processes the digital signal from modem 230 to form an analog signal in a first region of the L band frequency range for delivery to outdoor antenna unit 250. Receive RF unit 240 processes the analog signal in a second region of the L band frequency range, received from outdoor antenna unit 250, to form a digital signal that is further processed in modem 230. The processing elements or functions in transmit RF unit 235 and receive RF unit 240 include, but are not limited to, signal amplification, filtering frequency up/downconversion, and analog to digital signal or digital to analog signal conversion. The analog signal output from transmit RF unit 235 and the analog single input to receive RF unit 240 can be combined together using circuitry in transmit RF unit 235 and/or receive RF unit 240 to form a duplex signal for interfacing to outdoor antenna unit 250.

In outdoor antenna unit 250, diplexer 255 processes the duplex signal containing the signal for transmission from transmit RF unit 235 and the received signal for delivery to receive RF unit 240 to re-combine the two separate analog signals as described above. Diplexer 255 can include, but is not limited to directional couplers, signal power splitters, and filters, to perform the processing. Block upconverter 260 frequency converts the analog signal for transmission from the first region of the L band frequency range to a first region of the Ka or Ku frequency band. Block upconverter 260 can include elements such as frequency oscillators, mixers, filters, and the like. The block converted signal is amplified to a signal transmission power level in transmit amplifier 270. Transmit amplifier 270 can include, but is not limited to, high power transistor amplifiers, microwave filters, and electrical power converters. The amplified signal in the first region of the Ka or Ku frequency band is provided to antenna 280 for transmission through the air to a satellite (e.g., satellite 110 in FIG. 1).

A signal, in a second region of the Ka or Ku frequency band, is received from a satellite at antenna 280. The received signal is amplified in LNA 275 in order to raise the signal level to a level that can be properly provided to indoor unit 201. LNA 275 can include components such low noise microwave transistor amplifiers, microwave filters, and the like. Block downconverter 265 frequency converts the amplified received signal in a second region of the Ka or Ku frequency band to a second region of the L band frequency range. Block upconverter 260 can include elements such as frequency oscillators, mixers, filters, and the like. The analog signal in the second region of the L band frequency range is provided to diplexer 255 for interfacing to indoor unit 201 as part of a duplex signal as described above.

Antenna 280 can be any one of a number of types of large aperture high gain directional or beam antenna structures capable of communicating signals with one or more satellites at very high frequencies. Antenna 280 can include a mounting structure to attach the antenna to a surface, such as the ground, a mounting post or surface on a building. The mounting structure can include components to allow adjustment of the position of antenna 280 for both azimuth and elevation angle. In some embodiments, antenna 280 can be an antenna array containing a plurality of antenna elements arranged in a grid on a planar surface. The configuration and properties of the antenna elements in antenna 280 can allow for adjustment of the beam of antenna 280 electronically rather than through mechanical adjustment and/or physical movement of the antenna. The electronic adjustment can be used to account for a shifting or movement of antenna 280 such as ground or antenna mount shifting or when used as part of a portable terminal (e.g., terminals 145 in FIG. 1). The electronic adjustment can also be used to steer the beam of antenna 280 to track movement of a non-geostationary satellite. The electronic adjustment can further be used to reposition antenna 280 to communicate with a different satellite at a different location in the atmosphere. The electronic adjustment of antenna 280 can be performed during operation of terminal 200 in order to maintain communication with the network. While FIG. 2 illustrates components such as modem 230, transmit RF unit 235, and receive RF unit 240, within indoor unit 201, it should be noted that various embodiments can allow for part or all of one or more of these components to be included in the outdoor antenna unit 250. Further, parts of one or more components may be combined or rearranged without altering the overall function and purpose of terminal 200. Thus, the specific arrangement shown in FIG. 2 should only be considered as illustrative and is in no way intended to be restrictive.

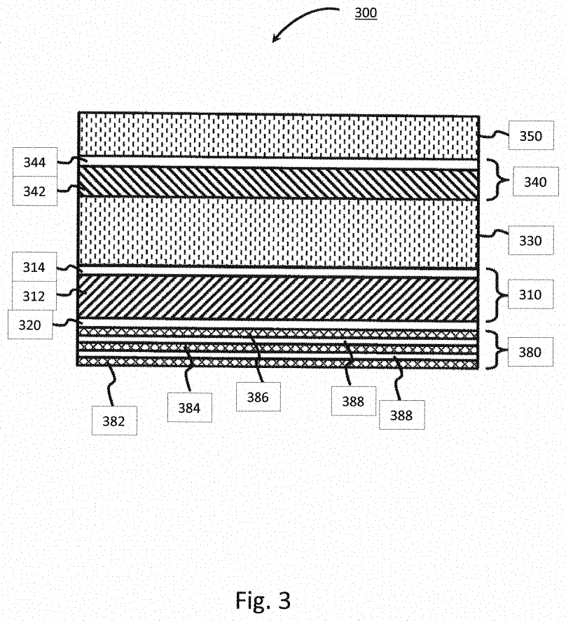

FIG. 3 illustrates a cross-sectional view of an outdoor antenna unit 300 in accordance with at least one embodiment. The outdoor antenna unit 300 includes an antenna patch 310, a ground plane 320, a polarizer spacer 330, a polarizer 340, and a dielectric cap 350. The ground plane 320 includes one or more coupling circuit patterns configured for coupling the outdoor antenna unit 300 with external components such as, for example, a PCB circuit assembly 380. According to various configurations, the PCB circuit assembly 380 can include multiple layers containing signal processing circuitry such as diplexer 255, block upconverter 260, block downconverter 265, transmit amplifier 279 and LNA 275 in FIG. 2). PCB circuit assembly can also include control circuitry, DC power distribution, RF power distribution, etc. According to the illustrated embodiment, the PCB circuit assembly 380 includes a first PCB layer 382, a second PCB layer 384, and a third PCB layer 386. An insulating layer 388 is provided between PCB layer 382 and PCB layer 384, and between PCB layer 384 and 386. The insulating layers 388 can be configured, for example, as dielectric layers. It should be noted, however, that the number of PCB layers can be increased or decreased depending on the specific design requirements.

As illustrated in FIG. 3, antenna patch 310 includes a first base 312 and first antenna patterns 314. According to the illustrated embodiment, the first antenna patterns 314 of the antenna patch 310 are formed directly on a top surface of the first dielectric base 312. Furthermore, the ground plane 320 (and coupling circuit patterns) is formed directly on, or abutted to, a bottom surface of the first base 312. In some embodiments, more than one antenna patch 310 can be included and positioned between first antenna patterns 314 and polarizer spacer 330. A polarizer spacer 330 is aligned with and disposed on the first circuit patterns 314 of the antenna patch 310. A polarizer 340 is subsequently provided on the polarizer spacer 330. According to the embodiment illustrated in FIG. 3, the polarizer 340 can include, for example, a second base 342 that is aligned with and disposed on the polarizer spacer 330. The polarizer 340 further includes second circuit patterns 344 formed on the second base 342. The dielectric cap 350 is subsequently disposed on the second circuit patterns 344. The PCB circuit assembly 380 is then connected electrically and/or physically to the ground plane 320 and, if necessary, the antenna patch 310.

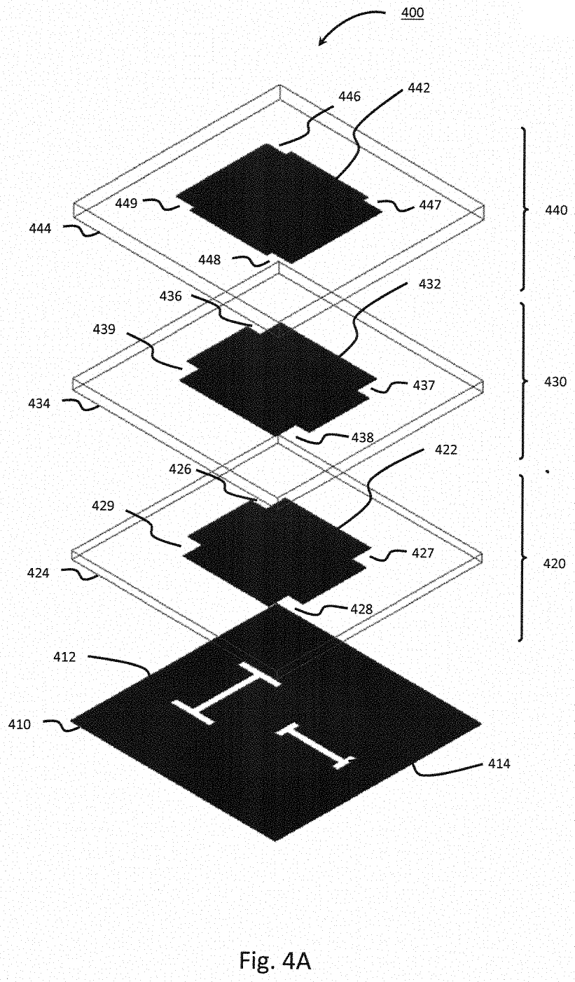

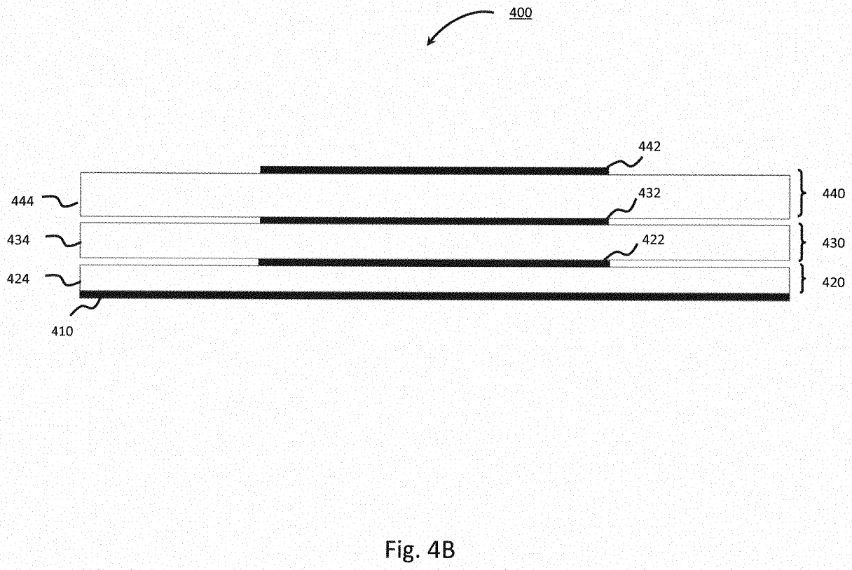

FIG. 4A illustrates an exploded view of an antenna structure 400 in accordance with at least one embodiment. FIG. 4B illustrates a cross-sectional view of the same antenna structure 400. Reference numbers identifying element of antenna structure 400 will be common between FIGS. 4A and 4B except where identified. Antenna structure 400 includes a ground plane 410, a first antenna patch 420, a second antenna patch 430, and a third antenna patch 440. Each of the antenna patches 420, 430, and 440 includes a base 424, 434, and 444 and a conductive element 422, 432, and 442 respectively. As illustrated, thickness of each of the bases 424, 434, and 444 is different. In other embodiments, the thickness can be the same depending on specific implementation and design considerations. The bases 424, 434, and 444 can each be constructed from various materials including dielectric material as described above. According to the illustrated embodiment, each of the conductive elements 422, 432, and 442 are formed on a top surface of the bases 424, 434, and 444 respectively such as in a manner similar to that described above. Each of the bases 424, 434, and 444 is larger in size (e.g. in one or both of the length and width dimension) that conductive elements 422, 432, and 442. Furthermore, the ground plane 410 is formed on, or abutted to, a bottom surface of base 424.

Ground plane 410 includes slots 412 and 414 that are void of conductive material. Slots 412 and 414 are referred to as feed couplings used as part of a slot coupled patch antenna. Slots 412 and 414 are configured to couple or interface electrical energy of a signal in the signal processing circuits (e.g., as part of PCB circuit assembly 380 in FIG. 3) to the electromagnetic energy used in transmission and reception of signals by antenna patches 420, 430, and 440. As illustrated, slots 412 and 414 interface to antenna patch 420. Slots 412 and 414 also interface to two separate feed lines that are formed as part of PCB circuitry for the antenna (e.g., PCB circuit assembly 380), not shown here. Antenna patch 420 further interfaces to antenna patch 430 and antenna patch 430 further interfaces to antenna patch 440. In this manner, antenna patch 420 is referred to as the driven antenna element and antenna patches 430 and 440 are referred to as parasitic antenna elements.

Each of conductive elements 422, 432, and 442 are rectangular in shape having a length and a width dimension. As illustrated, the length and width of each of conductive elements 422, 432, and 442 are the same. In other embodiments, the length and width of each can be different depending on specific implementation and design considerations. A patch antenna using a rectangular shaped conductive element such as described here has several properties or characteristics. First, the radiation efficiency, either transmitting or receiving, of the patch antenna is based on a proportional relationship between a given signal frequency and either the length or width dimension of the rectangular shape. Additionally, the radiated electromagnetic signal transmitted or received by the patch antenna will be linearly polarized along each axis formed by length and width of the rectangular shape. As such, the rectangular shaped patch antenna can radiate or receive two different signals, one signal associated with the axis formed by its length and a second signal associated with the axis formed by its width. These signals will also have high XPD to each other along the length and width axes of the patch antenna based on using fee couplings separately interfaced to a length side and a width side. As illustrated, slot 412 interfaces to the shorter side, or width, of the rectangular shape for use with a first signal used for transmission. Slot 414 interfaces to the long side, or length, of the rectangular shape for use with a second signal for receiving.

As illustrated in FIG. 4A, conductive element 422 further includes rectangular regions 426, 427, 428, are 429, positioned in each corner of the rectangular shape, that are void of conductive material. The inclusion of the rectangular regions 426, 427, 428, are 429 as conductive material exclusion regions within the rectangular shape of conductive element 422 reduces cross-polarization, or increases XPD, between a signal operating at the first frequency and a signal operating at a second frequency, such as described above, in each diagonal axis of the rectangular shape. Each of these rectangular regions 426, 427, 428, are 429 can have a length that is less than one half of the length of the rectangular shape and a width that is less than one half of the width of the rectangular shape. In one embodiment, each of the rectangular regions 426, 427, 428, and 429 can be symmetric about a central axis of the rectangular shape of conductive element 422. For example, the length of the rectangular regions 426, 427, 428, and 429 is parallel to the length of conductive element 422, and the width of rectangular regions 426, 427, 428, and 429 is parallel to the width of conductive element 422. The length and width of rectangular regions 426, 427, 428, and 429 can be determined based on finding a solution to a set of optimization equations having variables for the length and width and that can provide a level of XPD determined by, for instance, geometric constraints as well as design requirements.

As illustrated, conductive elements 432 and 442 also include rectangular regions 436, 437, 438, and 439 and 446, 447, 448, and 449 that respectively truncate the corners of the rectangular shape of those conductive elements. The lengths and widths of rectangular regions 426, 427, 428, and 429 and 436, 437, 438, and 439 are the same with the long side of those rectangular regions corresponding to the short side of the rectangular shape of conductive elements 422 and 432. The length and width of rectangular regions 446, 447, 448, and 449 are different, with the long side of the rectangular regions corresponding with the long side of rectangular shape of conductive element 442. In some other embodiments, lengths and widths of the sets of rectangular regions for each of the conductive elements 422, 432, and 442 can be different depending on specific implementation and design considerations. The lengths and widths of the sets of rectangular regions for each of the conductive elements 422, 432, and 443 can be determined collectively in a manner to that described above using three sets of variables for length and width. Further, the material thickness used for bases 424, 434, and 444 can be different based on design considerations and requirements for antenna structure 400.

FIGS. 4A and 4B implement a slot coupled patch antenna structure that includes three antenna patches 420, 430, and 440 along with a ground plane 410, referred to as a multilayer antenna or multi-layer patch antenna. In other embodiments, more of fewer antenna patches, with or without a ground plane can be used based on design considerations. For example, a single layer antenna or single layer patch antenna with one antenna patch along with a ground plane can advantageously utilize any of the principles of the present embodiments. Further, the use of rectangular conductive elements with separate slot coupling to the length and width of the elements allows two signals using different polarizations to be transmitted and/or received through the antenna structure because the slots naturally force the produced electric fields associated with the two signals to be orthogonal to each other in the principal plane (e.g., length and width) of the antenna structure. The truncated corners of the rectangular conductive elements further improve XPD in the diagonal plane of the antenna structure.

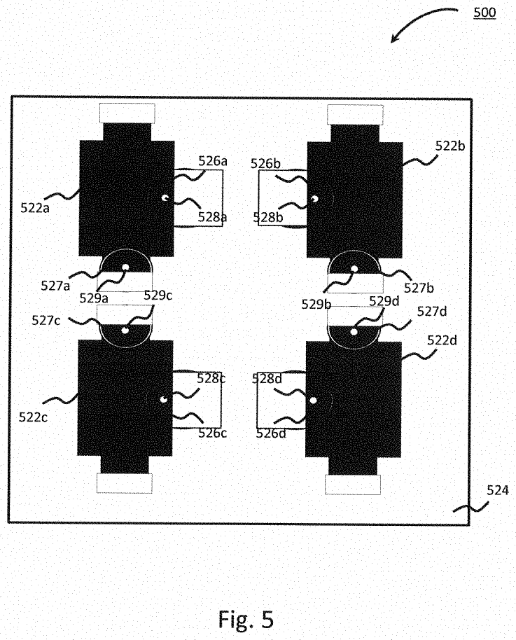

FIG. 5 illustrates a top view of an antenna structure 500 in accordance with at least one embodiment. Antenna structure 500 includes a base 524 and four conductive elements 522a, 522b, 522c, and 522d (collectively 522) disposed on base 524. Although not shown, a ground plane can be included as a separate layer (e.g., below base 524) in a manner similar to ground plane 410 in FIG. 4. Each of the four conductive elements 522 includes rectangular regions that truncate each of the corners similar to the antenna patches 420, 430, and 440. Each of the four conductive elements 522 includes a first feed coupling 526a, 526b, 526c, and 526d (collectively 526) and a second feed coupling 527a, 527b, 527c, and 527d (collectively 527), respectively. The first feed couplings 526 and the second feed couplings 527 are encompassed within the rectangular shape of the conductive elements 522 are semi-circular in shape containing conductive material having a diameter less than the dimension of the side of the conductive element containing the feed coupling. The first feed couplings 526 and the second feed couplings 527 are isolated or separated from conductive elements 522 by an arc that is void of conductive material.

Each of the first feed couplings 526 includes a first via 528a, 528b, 528c, and 528d (collectively 528), respectively. Additionally, each of the second feed couplings 527 includes a second via 529a, 529b, 529c, and 529d (collectively 529), respectively. First vias 528 and second vias 529 are conductive vias and form feed lines that couple to first feed couplings 526 and second feed couplings 527. Although not shown, the feed lines formed by first vias 528 and second vias 529 penetrate or pass through base 524 as well as a ground plane to a conductive circuit trace for a signal, as described earlier. Voids in the conductive material are used for the ground plane to prevent the feed lines from connecting to the ground plane First feed couplings 526 and second feed couplings 527 are configured to couple or interface electrical energy with a first signal and second signal in the signal processing circuits (e.g., as part of PCB circuit assembly 380 in FIG. 3) to the electromagnetic energy used in transmission and reception of those signals by antenna structure 500 in a manner similar to slots 412 and 414 in FIG. 4.

After assembling base 524, and the ground plane (not shown) together, a hole, smaller than the diameter of the circular conductive elements, is drilled or punched through the assembled base 524 and ground plane. A plating activator is applied, and a conductive material is electroplated onto the surface of each of the holes. As illustrated, conductive elements 522 in antenna structure 500 form a four element super unit cell. The conductive elements 522 are arranged in a two by two grid oriented in parallel with a common direction. Further, the first feed couplings 526 and second feed couplings 527 are arranged to be mirror symmetric about a central axis of base 524. The orientation and location of the first feed couplings 526 and second feed couplings 527 permit pairs of conductive elements 522 to be interfaced differentially to the circuitry for the first signal and the second signal. In one embodiment, a first signal can be differentially interfaced to conductive elements 522a and 522b through first feed couplings 526a and 526b. The first signal can also be differentially interfaced to conductive elements 522c and 522d through first feed couplings 526c and 526d. Further, a second signal can be differentially interfaced to conductive elements 522a and 522c through second feed couplings 527a and 527c. The second signal can also be differentially interfaced to conductive element 522b and 522d through second feed couplings 527b and 527d. In other embodiments, other arrangements can be possible. It should also be noted that the distance between conductive elements 522 on base 524 can be determined as a matter of design choice based on several factors including, but not limited to, the operating frequencies for the first signal and second signal, mutual coupling between the conductive elements, and XPD between the first signal and signal in the principal planes of the conductive elements.

A single rectangular shaped conductive element patch antenna using via feeds such as described in antenna structure 500 can have a lower cost of construction than the slot fed rectangular patch antenna described in FIG. 4. However, the slot fed rectangular patch antenna has superior XPD performance in the principal planes of the rectangular element. By including four conductive elements in a super unit cell and configuring the conductive elements as illustrated in FIG. 5, the cross-polarization present in the principal planes can be cancelled as a result of the presence of the adjacent conductive elements and provide XPD performance that equals or exceeds the slot fed rectangular patch antenna (e.g., antenna structure 400 in FIG. 4). The four element super unit cell described in FIG. 5 also includes truncated corners on each of the conductive elements that provide a performance improvement for XPD in the diagonal plane for each individual conductive element. Further, the truncated corners and the conductive elements as illustrated in FIG. 5 can also cancel remaining cross-polarization energy present between the conductive elements in the diagonal plane to further improve XPD in the diagonal plane. Although antenna structure 500 is described as a single layer patch antenna, other embodiments can employ the same aspects described in FIG. 5 in a multilayer patch antenna having any number of layers. Further, although antenna 500 is described as a super unit cell with four conductive elements, other embodiments can employ the same aspects described in FIG. 5 using more or fewer conductive elements.

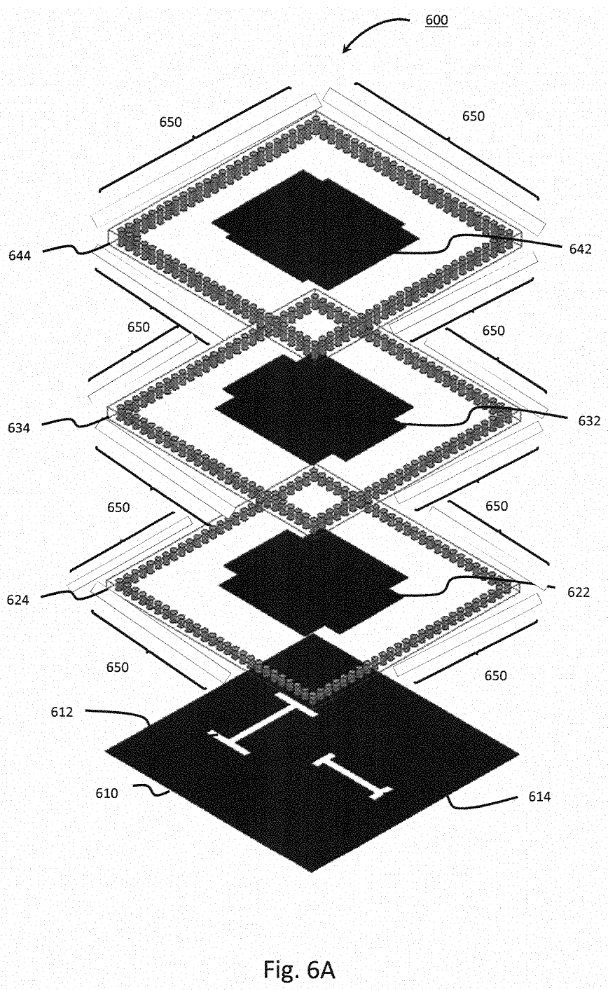

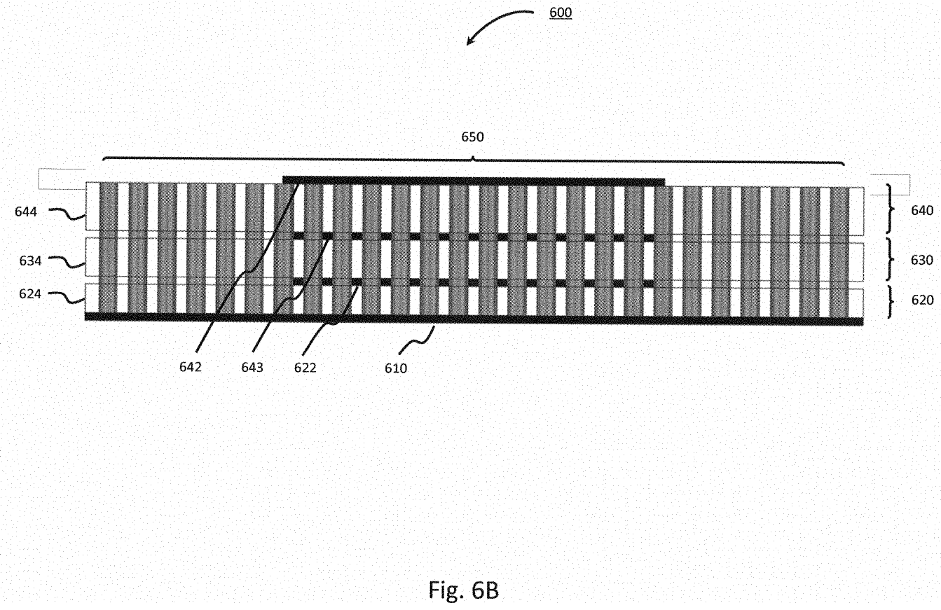

FIG. 6A illustrates an exploded view of an antenna structure 600 in accordance with at least one embodiment. FIG. 6B illustrates a cross-sectional view of the same antenna structure 600. Reference numbers identifying element of antenna structure 600 will be common between FIGS. 6A and 6B except where identified. Further, antenna structure 600 includes a ground plane 610 with slots 612 and 614, a first antenna patch 620 with base 624 and conductive element 622, a second antenna patch 630 with base 634 and conductive element 632, and a third antenna patch 640 with base 644 and conductive element 642 These elements are similar in construction and function as those similarly numbered elements described in FIGS. 4A and 4B and will not be described in further detail here except where noted.

Antenna structure 600 includes a plurality of vias or holes 650 which are disposed on the ground plane 610 and penetrate through each of the bases 624, 634, and 644. The plurality of vias 650 are conductive and plated through from the top surface of base 644 and connected to ground plane 610. The plurality of vias 650 arranged along all four edges of each base 624, 634, and 644. The plurality of vias 650 surround, but do not connect to, conductive elements 622, 632, and 642, thereby forming a conductive cavity. The plurality of vias 650 can be formed using one of several well-known multi-step processes. After assembling each of the bases 624, 634, and 644, and ground plane 610 together, a hole, smaller than the diameter of the circular conductive elements, is drilled or punched through the assembled bases 624, 634, and 644, as well as ground plane 610. A plating activator is applied, and a conductive material is electroplated onto the surface of each of the holes.

The conductive cavity formed by the plurality of vias 650 reduces the variation of characteristic impedance for antenna structure 600 over a range of beam pointing or beam steering adjustment through both elevation angle and azimuth angle. The conductive cavity can further reduce energy coupling to adjacent antenna structures (e.g. other antenna structures 600) when included as part of an antenna array or phased array antenna. The reduced coupling along with the reduced characteristic impedance variation improves the usable range of elevation angle as well as azimuth angle permitting an antenna array or phase array antenna to be electronically steered instead of completely or partially mechanically steered. In order for the conductive cavity to be effective, the distance or spacing between each of the plurality of vias 650 must be maintained to a value that is less than one-tenth of a wavelength associated with the operational frequency for a signal transmitted or received using antenna structure 600. Although antenna structure 600 is described as a three layer patch antenna, other embodiments can employ the same aspects can employ the same aspects described in FIGS. 6A and 6B in a single layer patch antenna or multilayer patch antenna having a different number of layers.

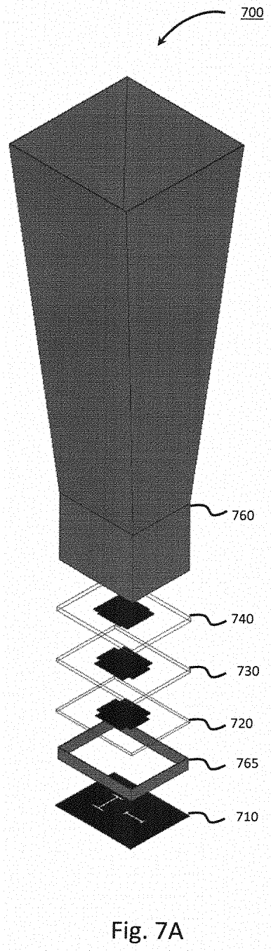

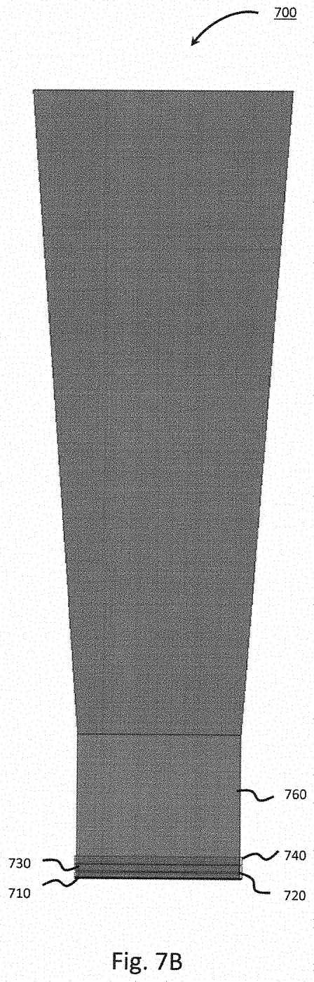

FIG. 7A illustrates an exploded view of an antenna structure 700 in accordance with at least one embodiment. FIG. 7B illustrates a cross-sectional view of the same antenna structure 700. Reference numbers identifying element of antenna structure 700 will be common between FIGS. 7A and 7B except where identified. The antenna structure 700 includes a ground plane 710, a first antenna patch 720, a second antenna patch 730, and a third antenna patch 740 which are similar in construction and function as those similarly numbered elements described in FIGS. 4A and 4B and will not be described in further detail here except where noted.

Antenna structure 700 also includes a waveguide horn 760. Waveguide horn 760 is a structure that can direct either transmitted or received radio signals in a beam pattern. Waveguide 760 can be constructed from a rigid conductive material and is flared outward from a smaller opening at one end to a larger opening at the opposite end. The smaller opening of waveguide horn 760 is coupled to the edge of the top surface of the base portion of antenna patch 740. An adaptor ring 765, illustrated in FIG. 7A, is coupled to ground plane 710 and is configured such that it surrounds the base portions of antenna patches 720, 730, and 740. Adaptor ring 765 can be used as a mechanical interface or mounting ring for waveguide horn 760 and can further be electrically coupled to ground plane 710. In one embodiment, waveguide horn 760 can have a rectangular opening that is slightly larger than the rectangular dimensions, in length and width, of the each of patch antennas 720, 730, and 740. Adaptor ring 765 can have similar rectangular dimensions and can be mechanically mounted and electrically connected to ground plane 710. Adaptor ring 765 can include an electrically conductive flange configured that mechanically attaches to waveguide horn 760.

In some embodiments, signal radiation manipulation elements can be included and/or disposed in the interior of waveguide horn 760. The radiation manipulation elements can include, but are not limited to, structures formed from dielectric or ferrite material, metallic shapes, and node structures that are configured as polarization elements, such as those described in FIG. 3. In operation, waveguide horn 760, along with adaptor ring 765, form a conductive cavity that reduces the variation of characteristic impedance for the range of beam pointing or beam steering adjustments through both elevation angle and azimuth angle also reduces coupling between adjacent structures when used in an antenna array in the same manner as described above in FIGS. 6A and 6B. Although antenna structure 700 is described as a three layer patch antenna, other embodiments can employ the same aspects described in FIGS. 7A and 7B in a single layer patch antenna or multilayer patch antenna having a different number of layers.

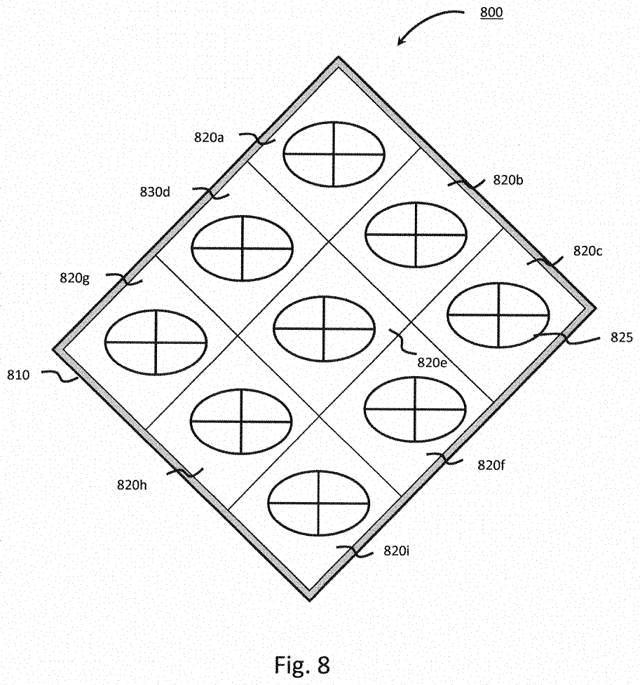

FIG. 8 illustrates a top view of an antenna array 800, according to one or more embodiments. Antenna array 800 includes a support frame 810 which can include, under certain embodiments, cross bracing or other support structures to protect antenna array 800 from environmental or physical damage. Antenna array 800 includes a set of antenna elements 820a, 820b, 820c, 820d, 820e, 820f, 820g, 820h, and 820i (collectively 820) that are arranged in a three by three grid within support frame 810. Each of the antenna elements 820 includes a radiating element for example, identified in element 820c as radiating element 825. Each radiating element is associated with transmitting and receiving a signal through antenna elements 820 during communication with a satellite as described above. As illustrated, the radiating element is typically a polarizer cap or polarizer element that is placed on top of an antenna structure, such as described in FIGS. 4-7. Each of the antenna elements 820 can be identical and use the same radiating element and accompanying antenna structure. In one embodiment, each of the antenna elements 820 in antenna array 800 can include an antenna structure similar to antenna structure 400 described in FIGS. 4A and 4B. Antenna elements 820 can further include a meanderline polarizer as the radiating element (e.g., radiating element 825) on top of each antenna structure. In other embodiments, each of the antenna elements 820 can include an antenna structure similar to antenna structure 500 in FIG. 5, antenna structure 600 in FIGS. 6A and 6B, or antenna structure 700 in FIGS. 7A and 7B.

Antenna array 800 can be mounted and oriented diagonally with respect to the azimuth plane. The orientation allows antenna array 800 to be electronically steerable, in both the azimuth plane and elevation plane. In order to implement electronic beam steering, each of the antenna elements 820 is assigned an amplitude and phase associated with the transmitted and received signals as part of a beam steering algorithm. Control for the beam steering can be performed in a processor included in antenna array 800 (e.g., as part of PCB circuitry 380 in FIG. 3). Control for the beam steering can also be performed in a processor included in a terminal device (e.g., CPU 205 in FIG. 2) and communicated to antenna array 800. The beam is formed from the composite or aggregate radiation pattern based on the individually assigned amplitude and phase for each of the antenna elements 820. The beam can be electronically adjusted by changing the amplitude and phase values associated with the transmitted and received signal for one or more of the antenna elements 820.

By including antenna structures, such as those described in FIGS. 4-7, the improved XPD in the diagonal plane for those antennas can improve XPD in the azimuth plane as well as the elevation plane for antenna array 800 based on its orientation. The improved XPD allows antenna array 800 to achieve electronic beam steering in both the azimuth and elevation plane. A fully electronically beam steering antenna array such as antenna array 800 is desirable because of its compactness as well lower cost associated with eliminating mechanical elements such as motors and adjustment elements used for mechanical beam steering. Further, antenna array 800 is capable of electronically implementing fast beam tracking often needed in networks using either moving satellites or portable terminals in motion. Although antenna 800 is implemented as a three by three grid of antenna elements, other embodiments can employ the aspects described in FIG. 8 using a grid containing more or fewer antenna elements.

Various features described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Furthermore, various features can be implemented using algorithms illustrated in the form of flowcharts and accompanying descriptions. Some or all steps associated with such flowcharts can be performed in a sequence independent manner, unless otherwise indicated. Those skilled in the art will also understand that features described in connection with one figure can be combined with features described in connection with another figure. Such descriptions are only omitted for purposes of avoiding repetitive description of every possible combination of features that can result from the disclosure.

The terms software, computer software, computer program, program code, and application program may be used interchangeably and are generally intended to include any sequence of machine or human recognizable instructions intended to program/configure a computer, processor, server, etc. to perform one or more functions. Such software can be rendered in any appropriate programming language or environment including, without limitation: C, C++, C#, Python, R, Fortran, COBOL, assembly language, markup languages (e.g., HTML, SGML, XML, VoXML), Java, JavaScript, etc. As used herein, the terms processor, microprocessor, digital processor, and CPU are meant generally to include all types of processing devices including, without limitation, single/multi-core microprocessors, digital signal processors (DSPs), reduced instruction set computers (RISC), general-purpose (CISC) processors, gate arrays (e.g., FPGAs), PLDs, reconfigurable compute fabrics (RCFs), array processors, secure microprocessors, and application-specific integrated circuits (ASICs). Such digital processors may be contained on a single unitary IC die, or distributed across multiple components. Such exemplary hardware for implementing the described features are detailed below.

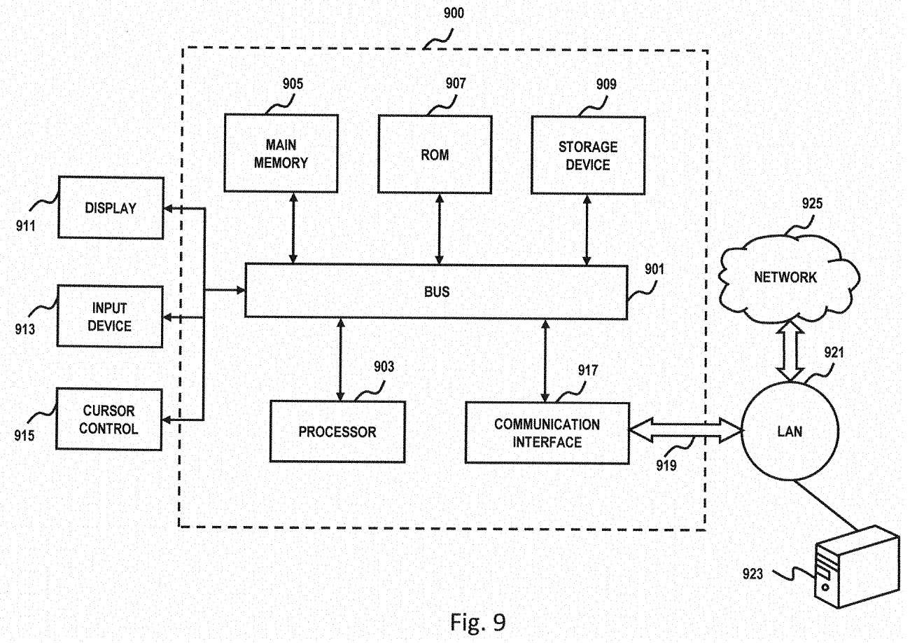

FIG. 9 is a diagram of a computer system 900 that can be used to implement various exemplary features and embodiments. The computer system 900 includes a bus 901 or other communication mechanism for communicating information and a processor 903 coupled to the bus 901 for processing information. The computer system 900 also includes main memory 905, such as (RAM), dynamic RAM (DRAM), synchronous dynamic RAM (SDRAM), double data rate SDRAM (DDR SDRAM), DDR2 SDRAM, DDR3 SDRAM, DDR4 SDRAM, etc., or other dynamic storage device (e.g., flash RAM), coupled to the bus 901 for storing information and instructions to be executed by the processor 903. Main memory 905 can also be used for storing temporary variables or other intermediate information during execution of instructions by the processor 903. The computer system 900 may further include a ROM 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a light emitting diode (LED) or other flat panel displays, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911. Additionally, the display 911 can be touch enabled (i.e., capacitive or resistive) in order to facilitate user input via touch or gestures.

According to an exemplary embodiment, the processes described herein are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multiprocessing arrangement may also be employed to execute the instructions contained in main memory 905. In alternative embodiments, hard-wired circuitry may be used in place of or in combination with software instructions to implement exemplary embodiments. Thus, exemplary embodiments are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, fiber optic service (FiOS) line, or any other communication interface to provide a data communication connection to a corresponding type of communication line. As another example, communication interface 917 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a High Definition Multimedia Interface (HDMI), etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 such as a wide area network (WAN) or the Internet. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an exemplary embodiment through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Non-volatile media can further include flash drives, USB drives, micro secure digital (SD) cards, etc. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a USB drive, microSD card, hard disk drive, solid state drive, optical disk (e.g., digital versatile disk (DVD), DVD read write (DVD RW), Blu-ray), or any other medium from which a computer can read.

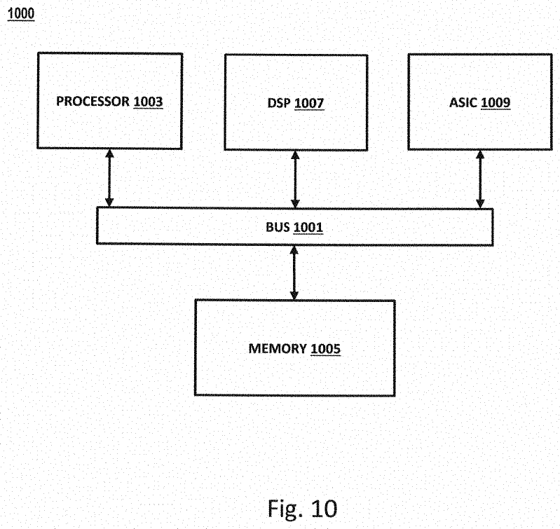

FIG. 10 illustrates a chip set 1000 upon which features of various embodiments may be implemented. Chip set 1000 is programmed to implement various features as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of the figures.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to perform specialized functions not easily performed by a general purpose processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, re-writable optical disk, etc.) and static memory (e.g., ROM, CD-ROM, DVD, BLU-RAY disk, etc.) for storing executable instructions that when executed perform the inventive steps described herein. The memory 1005 also stores the data associated with or generated by the execution of the inventive steps.

While certain exemplary embodiments and implementations have been described herein, other embodiments and modifications will be apparent from this description. Accordingly, the various embodiments described are not intended to be limiting, but rather are encompassed by the broader scope of the presented claims and various obvious modifications and equivalent arrangements.

What is claimed is:

1. An apparatus comprising:
a ground plane comprising a conductive material; and
an antenna patch disposed on the ground plane, and comprising:
a base portion formed from an insulating material, and
a conductive element disposed on the base portion and having a rectangular shape with a first length and a first width,
wherein the ground plane is larger than the conductive element,
wherein each corner of the conductive element includes a rectangular region void of conductive material, and
wherein the rectangular regions in each corner include a second length that is less than one half of the first length of the rectangular shape, and a second width that is less than one half of the first width of the rectangular shape.

2. The apparatus of claim 1, wherein:
the first length of the rectangular shape is based on a first operating frequency for the apparatus; and
the first width of the rectangular shape is based on a second operating frequency for the apparatus.

3. The apparatus of claim 2, wherein the first frequency is a frequency for transmitting a signal and the second frequency is a frequency for receiving a signal.

4. The apparatus of claim 2, wherein the inclusion of the rectangular regions in each corner of conductive element reduces cross-polarization between a signal operating at the first frequency and a signal operating at a second frequency along each diagonal axis of the rectangular shape.

5. The apparatus of claim 1, wherein the rectangular regions in each corner of the conductive element are symmetric about a central axis of the rectangular shape.

6. The apparatus of claim 5, wherein:
the second length of the rectangular regions is parallel to the first length of the conductive element, and
the second width of the rectangular regions is parallel to the first width of the conductive element.

7. The apparatus of claim 1, further comprising at least one additional antenna patch disposed on the antenna patch, each at least one additional antenna patch comprising:
a base portion formed from an insulating material, and
a conductive element disposed on the base portion and having a rectangular shape with a first length and a first width,
wherein the base portion is larger than the conductive element,
wherein each corner of the conductive element includes a rectangular region void of conductive material, and
wherein each rectangular region includes a third length that is less than one half of the first length of the rectangular shape, and a third width that is less than one half of the first width of the rectangular shape.

8. The apparatus of claim 7, wherein the third length is different from the second length, and the third width is different from the second width.

9. The apparatus of claim 1, further comprising at least one conductive via interconnecting the ground plane and the antenna patch.

10. The apparatus of claim 1, further comprising a plurality of conductive vias peripherally disposed on the ground plane, the plurality of cavity vias extending through the ground plane to a height equal to at least a height of a top surface of the antenna patch.

11. The apparatus of claim 1, further comprising a waveguide horn including a throat portion disposed on the base portion and surrounding the conductive element, the throat of the waveguide horn having a rectangular shape and having a length and width that are greater than the first length and width of the conductive element.

12. The apparatus of claim 1, wherein the insulating material of the base portion is a dielectric material.

13. The apparatus of claim 1, wherein the conductive element is a first conductive element and wherein the antenna patch further includes:
a second conductive element disposed on the base portion and having the rectangular shape with the first length and the first width, each corner of the second conductive element including the rectangular region void of conductive material;
a third conductive element disposed on the base portion and having the rectangular shape with the first length and the first width, each corner of the third conductive element including the rectangular region void of conductive material; and
a fourth conductive element disposed on the base portion and having the rectangular shape with the first length and the first width, each corner of the fourth conductive element including the rectangular region void of conductive material.

14. The apparatus of claim 13, wherein the first conductive element, second conductive element, third conductive element, and fourth conductive element are oriented in a two by two grid with the first length of first conductive element parallel to the first length of the second conductive element and the first length of the third conductive element parallel to the first length of the fourth conductive element, the two by two grid having mirror symmetry about a central axis on the top surface of the base portion.

15. The apparatus of claim 14, wherein each of the first conductive element, the second conductive element, the third conductive element, and the fourth conductive element each include a first signal coupling feed along one side having the first length and a second signal coupling feed along one side having the first width such that the first signal coupling feed and the second signal coupling feed interface to a differential signal.

16. An apparatus comprising:
an antenna array comprising a plurality of antenna elements, each antenna element comprising:
a ground plane comprising a conductive material; and
an antenna patch disposed on the ground plane, and comprising:
a base portion formed from an insulating material, and
a conductive element disposed on the base portion and having a rectangular shape with a first length and a first width,
wherein the ground plane is larger than the conductive element,
wherein each corner of the conductive element includes a rectangular region void of conductive material, and
wherein the rectangular regions in each corner include a second length that is less than one half of the first length of the rectangular shape, and a second width that is less than one half of the first width of the rectangular shape.

17. The apparatus of claim 16, wherein the antenna array can be configured for coupling to a terminal device.

18. The apparatus of claim 16, wherein the antenna array further comprises at least one polarizer for converting a signal in a first polarization to a signal in a second polarization.

19. The apparatus of claim 18, wherein the first polarization is a circular polarization.

20. The apparatus of claim 19, wherein the antenna array is electronically steerable in a range of elevation angles and a range of azimuth angles when receiving a circular polarized signal.
